(19) United States
(12) Patent Application Publication
(10) Pub. No.: US 2024/0289423 A1
(43) Pub. Date: Aug. 29, 2024

(54) SYSTEMS AND METHODS FOR GNSS AUGMENTATION VIA TERRAIN-BASED CLUSTERING INSIGHTS

(71) Applicant: ClearMotion, Inc., Billerica, MA (US)

(72) Inventors: William Graves, Somerville, MA (US); John Parker Eisenmann, Burlington, MA (US); Marco Giovanardi, Melrose, MA (US); Ardashir Hormuz Bulsara, Waltham, MA (US)

(73) Assignee: ClearMotion, Inc., Billerica, MA (US)

(21) Appl. No.: 18/572,873

(22) PCT Filed: Jun. 21, 2022
(86) PCT No.: PCT/US2022/034355

§ 371 Date: Dec. 21, 2023

Related U.S. Application Data
(60) Provisional application No. 63/296,531, filed on Jan. 5, 2022.
(60) Provisional application No. 63/213,396, filed on Jun. 22, 2021.

(51) Int. Cl. G06F 18/23; G01S 19/40; G01S 19/42

(52) U.S. Cl. CPC G06F 18/23; G01S 19/40; G01S 19/42

(57) ABSTRACT

Methods and systems related to determining the ordering and/or positioning of travel lanes on a road segment are disclosed. In some embodiments, this may include obtaining and clustering road surface profiles associated with a road segment using, for example, a degree of similarity or other appropriate metric. A lateral offset or position of the clustered profiles may be used in determining the lane ordering and/or position. The resulting lane specific information may be used to determine a travel lane for a vehicle by comparing a current road-profile obtained from the vehicle and the road profile information associated with the different lanes. In other embodiments, a method and/or system for augmenting a global navigation satellite system (GNSS) signal may include using a raw GNSS signal and a GNSS location associated with terrain-based data to determine a lateral offset for use in determining a corrected GNSS location of the vehicle.

### RELATED APPLICATIONS

This application claims the benefit of priority under 35 U.S.C. § 119(e) of U.S. Provisional Application Ser. No. 63/296,531, filed Jan. 5, 2022 and U.S. Provisional Application Ser. No. 63/213,396, filed Jun. 22, 2021, the disclosures of each of which are incorporated herein by reference in their entirety.

### SUMMARY

According to one aspect, this disclosure discusses a method of determining the ordering of lanes in a road segment that may have multiple lanes. The method may include: receiving multiple road profiles (e.g. road surface or subsurface profiles), where each road profile is based on data collected during each of multiple traverses of the road segment; determining a representative lateral offset of each drive path when each road profile was collected during each traverse (for example by using a GNSS system); determining a degree of similarity among the multiple road profiles; clustering the road profiles based on their degree similarity, where the profiles with similarities greater than a preset threshold value may be associated with the same lane of travel; determining an average of the representative lateral offsets of the drive paths associated with each road surface profile in each cluster; and based on the averages of the representative lateral offsets of the drive paths associated with each road surface profile in each cluster, determining the number of lanes of travel in a road segment (marked or unmarked), ordering of the lanes of the road segment and/or the lateral offset of multiple lanes or travel relative to an appropriate baseline. In some implementations, the method may also include determining the spacing between a calculated center line of at least two lanes of the road segment.

According to one aspect, this disclosure discusses a method of determining a lateral position of a drive path or travel lane in a road segment. The method may include: traversing the road segment, by traveling along multiple drive paths in the road segment, with one or more vehicles; determining a road-surface profile and a lateral position of each of the drive paths; clustering the road-surface profiles based on their similarity; identifying a first cluster that includes a sufficient number of road-surface profiles, where the sufficient number is a number equal to or greater than a preset threshold value; determining a representative road-surface profile of the first cluster; determining a representative lateral position of the set of drive paths corresponding to the road surface profiles in the first cluster; and determining a lateral position of a travel lane based on an average of representative lateral position of the drive paths that are associated with the road surface profiles in the first cluster. In some implementations, the representative lateral positions of a given drive path may be determined based on a single lateral position measurement or an average of multiple lateral position measurements (e.g. by using a GNSS receiver on-board a vehicle) made while traveling along the drive path. In some implementations, the lateral position of a travel lane may be equal to an average of the representative lateral position of the set of drive paths corresponding to the road surface profiles in the first cluster. In some implementations, the lateral position of a given drive path is based on one or more GNSS measurements while traveling along the drive path. In some implementations, the number of lanes is equal to the number of clusters that include a sufficient number of road-surface profiles. In some embodiments, the method may include determining the current lane of a vehicle based on matching a current road-surface profile with previously determined representative road data associated with a travel lane. In some embodiments, the representative road-surface profile data may be received from a remote data storage system, e.g., cloud storage.

According to one aspect, this disclosure discusses a method of determining the ordering of lanes in a road segment. The method may include: receiving information about the characteristics of subsurface structures below multiple drive paths, where the characteristics are based on data collected while driving over each of the drive paths of the road segment; determining a representative lateral offset of each of the drive paths of the road segment; determining a degree of similarity between the information received about the sub-surface characteristics of the multiple drive paths; clustering the information, where the clusters with similarities greater than a preset threshold value are associated with the same lane of the road segment; determining an average of the representative lateral offsets associated with each of the drive paths in each cluster; and based on the averages, determining the ordering of the lanes of the road segment.

According to one aspect, the present disclosure provides a method of augmenting or correcting real-time GNSS signal corresponding to a current location of a vehicle. The method includes (a) receiving, from a GNSS sensor on-board a vehicle, a GNSS signal that corresponds to a current location of the vehicle as the vehicle travels on a road segment, (b) receiving, from one or more other sensors on the vehicle, current terrain-based data corresponding to the road segment on which the vehicle is traveling, (c) localizing the vehicle to a lane of travel of the road segment based on a comparison of the current terrain-based data from (b) with stored terrain-based data associated with one or more lanes of the road segment, (d) calculating a lateral offset or discrepancy between the position based on the GNSS signal and the location based on the terrain-based data, and (e) applying the lateral offset to the raw GNSS data to determine a corrected GNSS location of the vehicle for subsequent positions of the vehicle for a period of time.

In some implementations, the method also includes transmitting the corrected GNSS location of the vehicle to one or more controllers on the vehicle. In some instances, the one or more controllers on the vehicle includes at least one of an ADAS controller, a semi-autonomous driving controller, or an autonomous driving controller.

In some implementations, the method also includes recalculating the lateral offset each time the vehicle travels a predetermined distance.

In some implementations, the method also includes recalculating the lateral offset at the end or at the beginning of each road segment.

In some implementations, the method also includes determining a GNSS error for a particular region based on the lateral offset between the raw GNSS signal and a GNSS location associated with the stored terrain-based data and transmitting the GNSS error to other vehicles in the region.

According to one aspect, the present disclosure provides a method of determining a lane of travel of a vehicle while the vehicle is traveling along a multi-lane road segment. The method includes collecting current road-profile information with at least one on-board sensor; receiving previously collected representative road-profile information and representative lateral position data about each of the at least two lanes of travel associated with the road segment, from a database; comparing the current road-profile information with the representative road-profile information received about each of the at least two lanes of travel; and selecting a lane of travel, from among the at least two lanes of travel associated with the road segment, with representative road-profile information most similar to the current road-profile information; and determining the current lane of travel to be the selected lane of travel. In some implementations of the method the lane of travel is an unmarked lane of travel associated with the road segment. In some implementations of the method the current road profile information is a current road-surface profile, and each previously collected representative road-profile information is a previously collected representative road-surface profile. In some implementations, the method also includes determining the lateral position of the current lane of travel to be the lateral position of the selected lane of travel. In some implementations, the method also includes determining a first lateral position of at least one point along the current lane of travel, based on information from a GNSS receiver when the vehicle is located at the at least one point; determining a second lateral position of the at least one point along the current lane of travel, based on the lateral position of the current lane of travel; and based at least on a discrepancy between the first lateral position and the second lateral position, determining a error in the information received from the GNSS receiver.

### BRIEF DESCRIPTION OF DRAWINGS

FIG. 1 illustrates an exemplary two-lane road segment;

FIG. 2 Exemplary probability density function of the Global Navigation Satellite System (GNSS) based lateral position coordinates of vehicles traveling in the right lane of the road segment shown in FIG. 1;

FIG. 3 illustrates the cumulative distribution function of the underlying distribution of FIG. 2;

FIG. 4 Exemplary probability density function of the GNSS based lateral position coordinates of vehicles traveling in the right and left lanes of the road segment shown in FIG. 1;

FIG. 5 illustrates an exemplary distribution of lateral offset readings resulting from 10 traverses of the road segment in each lane;

FIG. 6 illustrates the grouping of lateral offset readings associated with each lane in FIG. 1;

FIG. 7 illustrates an exemplary method for determining which grouping in FIG. 6 belongs to the left lane of the road segment in FIG. 1 and which belongs to the right lane.

FIG. 8 illustrates an example of a GNSS augmentation performed based on terrain-based information.

FIG. 9 illustrates an exemplary method for performing a GNSS augmentation based on terrain-based information.

### DETAILED DESCRIPTION

In some embodiments, when a vehicle travels along a road (or segment of a road), data related to the road surface may be collected, by using one or more sensors (e.g., accelerometers, position sensors, etc.) attached to one or more points of the vehicle (e.g., attached to a wheel of the vehicle, a wheel assembly of the vehicle, a damper, an unsprung mass of the vehicle, or a part of the sprung mass of the vehicle). This data may be used to map certain characteristics of the surface, by e.g., determining the road surface profile, and/or the presence, location and/or extent of various irregularities. It is noted that this disclosure describes the use of road surface characteristics, such as road-surface profile, in conjunction with GNSS to determine the number of lanes in a road segment and/or their relative lateral position. It is further noted, however, that subsurface characteristics of a road, for example, as determined by ground penetrating radar, may be used in addition to or instead of road surface characteristics in the embodiments disclosed herein. Use of subsurface characteristics, in addition to or instead of road surface characteristics, is contemplated, as the disclosure is not so limited.

In some embodiments, road-surface characteristics of a road-segment may be mapped by combining (e.g., by averaging) data collected during multiple traverses of the road segment, by one or more vehicles. For example, in some embodiments, road surface profile data from multiple traverses of a road segment may be averaged to generate a representative road surface profile of the road segment. Such a representative road surface profile may be stored remotely, e.g., in the cloud or on-board the vehicle, and subsequently provided to a vehicle or otherwise made available. A vehicle receiving or accessing such data, e.g. from the cloud or on-board data storage, may also collect current road surface information. By comparing the current data collected by a vehicle during a current trip with the previously stored road surface data, e.g., the road-surface profile, the vehicle may determine its longitudinal position on the road surface.

However, in multi-lane roads the surface characteristics and/or sub-surface characteristics of various lanes may lack similarity so that the averaged data, e.g., averaged road-surface profile based on data from multiple lanes, may not be representative of any one lane of travel or of the road segment as a whole. Additionally, the surface and/or sub-surface characteristics, e.g., road-surface and/or subsurface profile, of one lane of a multi-lane road may be sufficiently different from the road-surface or sub-surface characteristics of a second lane, such that a vehicle travelling along the latter may not be able to localize based on a comparison between previously stored and current data received, e.g., from the cloud. Thus, in some embodiments it may be desirable to know the representative characteristics, e.g., road surface profile, of each of multiple lanes in a multi-lane road.

The Inventors have recognized that data collected from multiple lanes in a multi-lane road, during multiple traverses, may be used to determine both the number of lanes and the characteristics, e.g., road-surface profile, of two or more of those lanes. In some embodiments, the number of lanes and the surface characteristics each of those lanes may be determined without reliance on a priori knowledge of the number of lanes and/or the lane of travel during any of the traverses during which data is collected.

In some embodiments, road profile information may be obtained from multiple trips along a road segment, by one or more vehicles, over multiple lanes of the road segment and stored, e.g., in the cloud. In some embodiments, each road profile record in a data set may correspond to a different traverse of a given road segment. For example, the set of road profiles may correspond to a single vehicle traversing the given road segment multiple times. A distinct road profile may be measured and stored on multiple occasions when a vehicle traverses the road segment. Alternatively, data may be collected by multiple (different) vehicles as they traverse a given road segment, and a distinct road profile may be measured on each of the multiple traverses. Such data may be collected by any appropriately equipped and configured vehicle (e.g., a vehicle equipped with hardware and software to obtain road profiles and to transmit the obtained road profile information for remote storage, e.g., on the cloud) that traverses the road segment, thereby yielding the set of road profiles for a road segment.

In certain embodiments, once it is determined that the set of road surface characteristics, e.g., road profiles along the length of the road segment, includes a sufficiently large number of samples, a correlation clustering algorithm may be applied to the data set. Correlation clustering algorithms that may be used may include, for example, hierarchal or partitional clustering methods (e.g., k-means clustering, c-means clustering, principal component analysis, hierarchal agglomerative clustering, divisive clustering, Bayesian clustering, spectral clustering, etc.). Based on the results of the clustering procedure, the set of road characteristics, e.g., road surface profiles, may be divided into one or more clusters, wherein each road profile contained within a given cluster is substantially or sufficiently similar to each other road profile(s) contained within the given cluster. In some embodiments, the algorithm may ignore certain road profiles that do not appear to be in a sufficiently large cluster. For example, a portion or all of the set of road profiles based on data collected while traversing a road segment multiple times may be divided into at least a first cluster of road profiles and a second cluster of road profiles, wherein each road profile in the first cluster is substantially or sufficiently similar to each other road profile in the first cluster, and each road profile in the second cluster is substantially or sufficiently similar to each road profiles in the second cluster.

In certain embodiments, each cluster may be representative of a single lane of travel of the road or road segment. In certain embodiments, some or all of the average characteristics of the cluster, e.g., the road-surface profiles within a given cluster, may be averaged, in order to obtain a single representative road surface characteristic of a particular lane. This lane-averaged road profile may serve as the reference or representative road profile for a given lane within a road segment. Such reference or representative road profile information may be used, for example, for terrain-based localization or preview control of vehicles (e.g., controlling one or more vehicular systems, e.g. active or semi-active suspension, steering, and/or braking systems) based on knowledge of upcoming road surface characteristics). Such information may be stored in a database and associated with a specific lane in a road segment. As used herein, the term “terrain-based localization” refers to a process of locating or determining the position of a vehicle based at least partially on a comparison of road profile information (e.g. road surface profile and/or sub-surface profile) collected by a vehicle during a current traverse of a road segment with previously stored road profile information (e.g. road surface profile and/or sub-surface profile) associated with the road segment.

This averaging may be carried out for each identified cluster. In certain embodiments, the clustering algorithm may be periodically repeated (e.g., after a certain number of new road profiles are collected for a given road segment). Alternatively, the clustering algorithm may be repeated after each new road profile data is collected to determine which cluster the most recent profile belongs to.

In some embodiments, the clustering may utilize an agglomerative hierarchical method which initializes each road profile as its own cluster and then recursively merges the pair of most similar clusters until a stopping criteria is met. In some embodiments, the stopping criteria may consist of a few different booleans related to the absolute similarity of the candidate pair of clusters, the relative similarity of the hypothetical merged cluster to the original pair of clusters, and the valid frequency range of each cluster's road profile. Road profiles can be excluded from the clustering process altogether for various reasons. For example, if lateral maneuvers deviating from a road's expected curvature or lane change maneuvers are detected, the particular road profile may be excluded and not associated with a particular cluster or lane.

In some embodiments, rather than considering each cluster to represent the characteristics of a lane, only clusters having a number of road profiles that exceed a certain threshold value may be considered to be lanes. For example, a cluster with a single road profile or a small number of profiles less than a threshold value, may be considered to be outlier(s), rather than a distinct lane. Outliers may occur, for example, when a vehicle changes lanes, leaves and re-enters a lane, or leaves the road altogether. In certain embodiments, road profiles considered outliers may be deleted or otherwise ignored, e.g., after preset time period in order to conserve storage, not cause confusion, or other appropriate reasons.

As used herein, the term “lane” refers to a path of travel of a vehicle traversing a road segment. Lanes may be physically marked by lane dividers or markings or unmarked. For example, a road segment without lane markers may still have multiple lanes.

As used herein, the term “road segment” refers to a continuous portion of a road, in a road network, with a beginning and an end, that is of any appropriate length. It may be straight or curved and may include intersections with other roads or road segments.

The Inventors have recognized that clustering may be used to determine: the number of lanes of travel in a road segment (marked or unmarked) and the associated representative or reference road surface profile (or sub-surface profile) of each lane. However, this method may not indicate the relative lateral positioning or ordering of the identified lanes.

The inventors have further recognized that as a vehicle traverses a road segment, one or more lateral position coordinate(s), e.g. relative to the road surface, may be associated with the particular path taken during the traverse. The lateral position may be determined by using data received from, for example, a GNSS (e.g., GPS) receiver on-board the vehicle. In some embodiments, this lateral position information may also be associated with one or more road surface and/or sub-surface characteristics, e.g., road surface profile, measured during the traverse. The lateral position, associated with the traverse, may be determined, for example, at a random point during the traverse, or at a particular preselected longitudinal position (e.g., at the beginning, middle or end of the road segment). Alternatively, the lateral position associated with the traverse and/or the road surface characteristics may be determined by averaging multiple lateral position readings obtained during a given traverse.

In some embodiments, after road surface characteristics, e.g., road profiles, road surface profiles, road sub-surface profiles, have been clustered, the lateral position of each cluster may be determined by averaging the lateral position readings associated with each member of the cluster. The average lateral position of each cluster may then be associated with the lateral position of the lane. The average lateral position of each lane determined in this way may be used to additionally determine: the lateral position of a given lane in a multi-lane road segment. The Inventors have recognized that a combination of the clustering of road surface profiles and GNSS tracking of vehicle traversing a road segment, may be used to deduce, for example: the lateral position of a lane relative to a road segment, the absolute lateral position of a lane, the number of lanes in a multi-lane road segment and the ordering of those lanes. The Inventors have further recognized that the lane of travel of a vehicle may be determined by comparing current road surface information, e.g. road-surface profile and/or road sub-surface profile, with pre-recorded average, lane-specific, road surface and/or sub-surface characteristics in a multi-lane road segment.

In some embodiments, lane ordering may be achieved by: 1) Collecting terrain-based data from multiple traverses of a road surface, by one or more vehicles; 2) Clustering the data to determine which drives are associated with each of the two or more lanes; 3) Averaging the GNSS coordinates associated with each traverse in each lane; and 4) Determining the ordering and/or positioning of the lanes based on the averaged GNSS coordinates of each lane.

In some embodiments, by averaging the GNSS traces from multiple drives, the lateral offset accuracy of GNSS readings may be improved by mitigating slowly changing lateral offsets of GNSS readings. As used herein, the term “slowly changing lateral offsets” refers to inherent lateral GNSS position errors that do not change significantly during a traverse of a road segment. In some embodiments, GNSS data from at least five traverses but less than 10 traverses may be averaged to achieve a sufficient level of lateral offset accuracy and to effectively determine lane ordering. In some embodiments, data from at least five traverses but less than 20 traverses may be averaged to achieve a sufficient level of lateral offset accuracy and to effectively determine lane ordering. In some embodiments, data from at least five traverses but less than 1000 traverses may be averaged to achieve a sufficient level of lateral offset accuracy and to effectively determine lane ordering. However, the number of traverses both above and below the above ranges are contemplated, as the disclosure is not so limited.

In some embodiments, knowledge of the absolute or relative lateral position and/or ordering of lanes in a given road segment may be useful to more quickly determine the location of a vehicle. For example, in some embodiments, such information may be used to determine which lane a vehicle is traveling in after a perceived lane change before having to rely on road profile pattern matching. For example, if it is known, or known to a sufficient degree of certainty, that a vehicle is travelling in Lane X (e.g. the right lane in a three lane road) and a subsequent lane change maneuver, to the left, is detected (e.g., based on a signal from an IMU or other sensor capable of detecting yaw), this information may be used as an indication that the vehicle is in a lane that is to the left of Lane X (e.g. the center lane). Without such information, the new location may be determined by using one or more localization techniques, e.g., terrain-based localization in a “lane seek” mode. In such mode, road profile collected by the vehicle may be compared to road profile of all or several previously collected road surface profiles of known lanes in the road. The lane in which the vehicle is traveling may then be determined after a profile match is found. A lane seek mode may be more time consuming and/or more computationally intensive than, for example, determining or estimating the lane of travel based on a yaw sensor reading and knowledge of lane ordering. For example, in some embodiments, the lane of travel of a vehicle may be determined based on information from on-board sensors (e.g., an IMU, one or more accelerometers) and information about lane ordering, before or without relying on localization techniques, such as for example, vision or matching of a current road surface profile after a maneuver with stored representative road-surface profiles of multiple lanes.

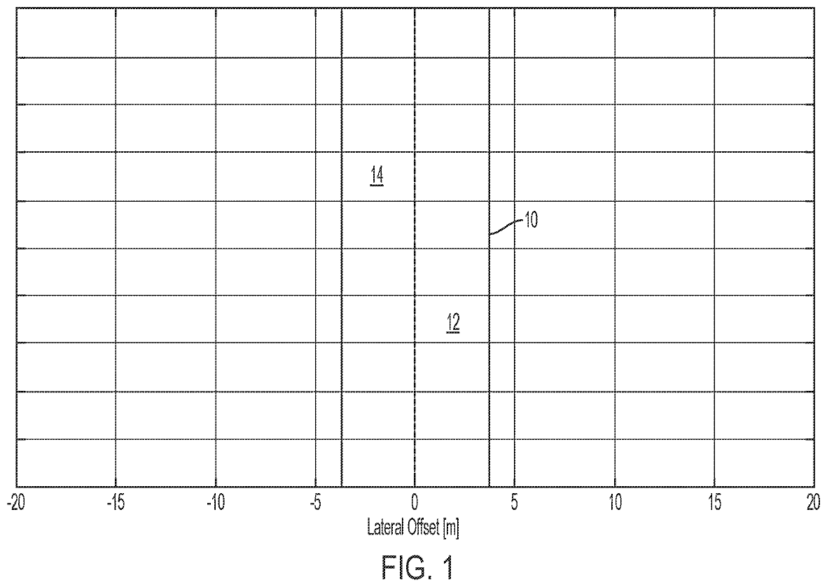

FIG. 1 illustrates an exemplary road segment 10 which includes right lane 12 and left lane 14. In this example, the lanes are marked, and each lane is 3.7 meters wide. However, marked and unmarked lanes that are both wider and narrower than those illustrated in FIG. 1 are contemplated, as the disclosure is not so limited. In the subsequent figures, note that the y-axis (or longitudinal axis) changes to represent different quantities while the x-axis consistently shows lateral offset.

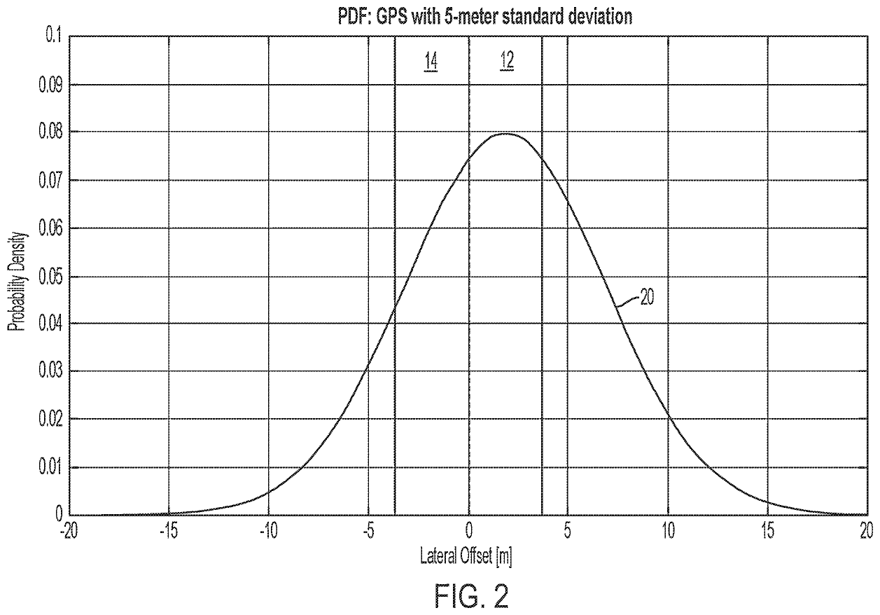

In some embodiments, a vehicle traveling along the road segment in FIG. 1 may include an on-board GNSS receiver. Errors in a GNSS measurement, using such a receiver, may have a standard deviation of approximately 5 or more meters. For example, an exemplary GNSS receiver on-board a vehicle traveling in lane 12 may exhibit a probability density function 20 shown in FIG. 2. As shown in FIG. 2, a significant portion of the distribution lies outside the right lane, e.g., on the left side of the road's center line (i.e., the left lane 14 in the example illustrated in FIG. 2). In some embodiments the standard deviation of lateral position of a vehicle measured by GNSS may be in the range of 5-10 meters. Standard deviations both greater and less than a range of 5-10 meters are contemplated, as the disclosure is not so limited.

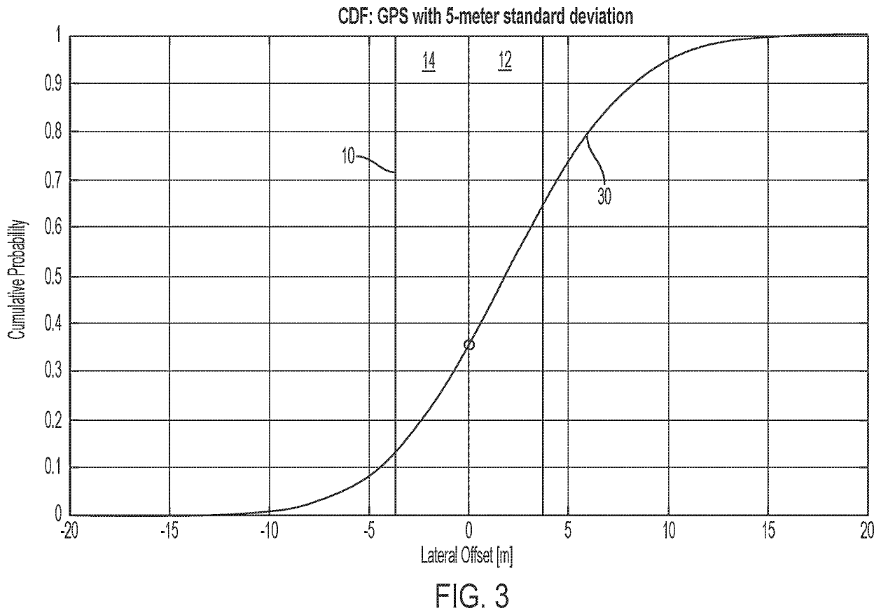

FIG. 3 illustrates the cumulative distribution function 30 of the underlying distribution of FIG. 2. In FIG. 3, approximately 35% of the area under the curve lies on the left side of the centerline of the road segment 10. Therefore, according to the cumulative distribution function 30, for each vehicle traveling in the right lane of road segment 10, there is approximately a 35% probability that a system using GNSS alone may indicate that the vehicle is in the left lane despite it actually being in the right lane. Randomly guessing which lane of the road in FIG. 1 the vehicle is traveling in, e.g., by flipping a coin, has a 50% probability of being correct.

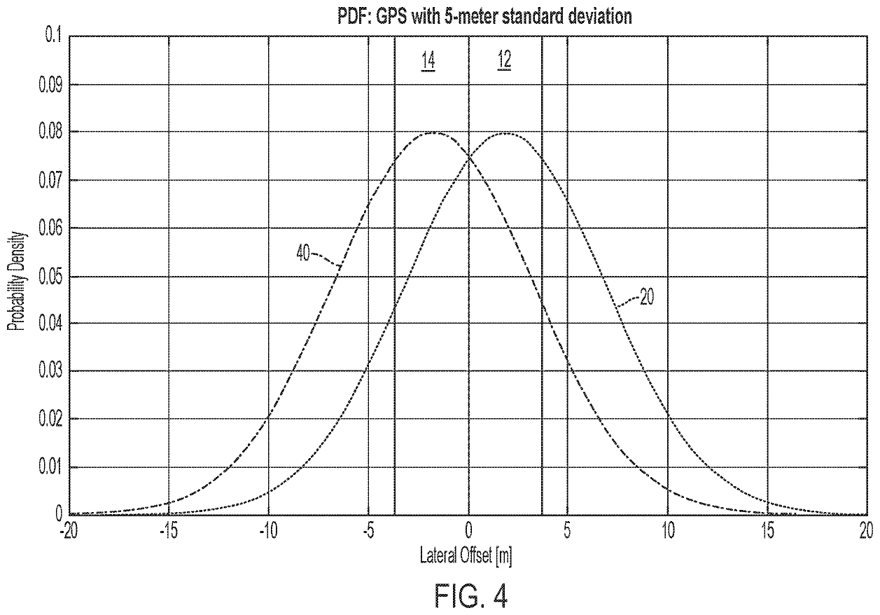

FIG. 4 illustrates the probability density function 20 for vehicles actually traveling in the right lane and the probability density function 40 for vehicles actually traveling in the left lane. In the example illustrated in FIG. 4, the lateral GNSS coordinates of any vehicle traveling on road segment 10 may be determined by one of these distributions, depending on which lane the vehicle is actually traveling in.

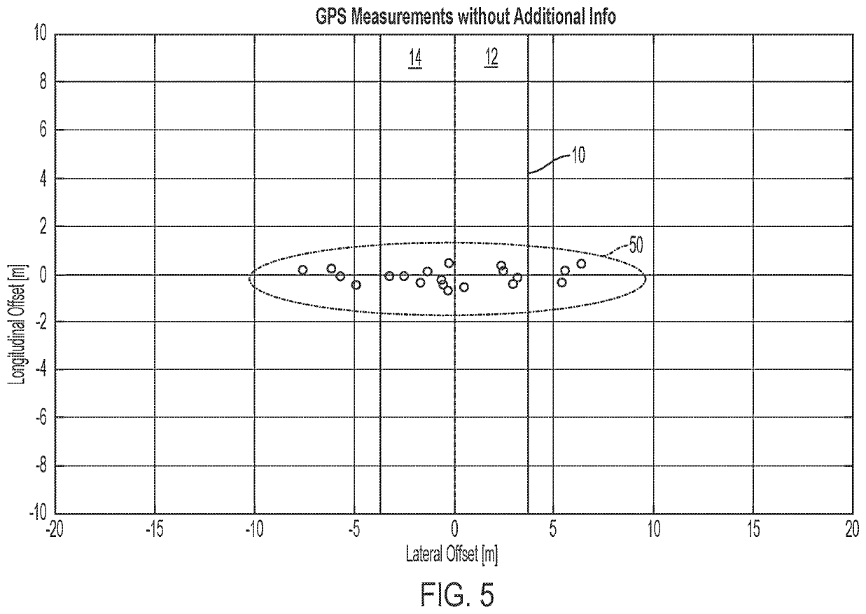

In FIG. 5, the 20 open circles 50 represent 20 lateral offset readings, at a particular longitudinal position of road segment 10, associated with 10 traverses in the right lane 12 and 10 traverses in the left lane 14 of the road segment 10. In the example illustrated in FIG. 5, the readings associated with the 10 vehicles traveling in the left lane cannot be effectively differentiated from the readings from the readings associated with the 10 vehicles traveling in the right lane, based only GNSS coordinate readings. This is because of the inherent inaccuracy of GNSS readings illustrated in FIG. 4.

However, clustering based on terrain-based similarity of road surface or sub-surface characteristics, e.g., road surface profile, GNSS data collected during 20 traverses of the road segment in FIG. 5 may be grouped based on the lane of travel. The lateral offsets from drives that were in the same lane may be grouped together and associated with particular lanes independently from the GNSS measurements. As discussed above, terrain-based clustering may also indicate the number of lanes in a road segment without a priori knowledge of that number. However, the clustering analysis may not be sufficient to indicate the relative positioning of the lanes. After the clustering step, the relative position of the lanes identified by clustering may not be apparent.

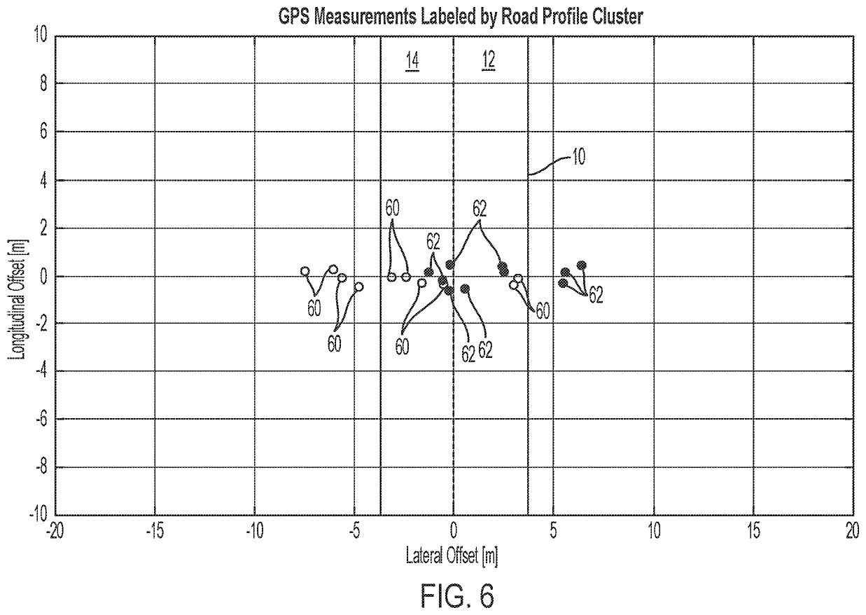

In FIG. 6 the open circles 60 represent readings associated with the first of the two lanes while full circles 62 represent the readings associated with a second lane. In FIG. 6, the circles 60 and 62 are plotted according to the lateral offset that each circle represents. By comparing the averages of the full circles and the open circles, it may be determined that first lane is located to the left of the second lane.

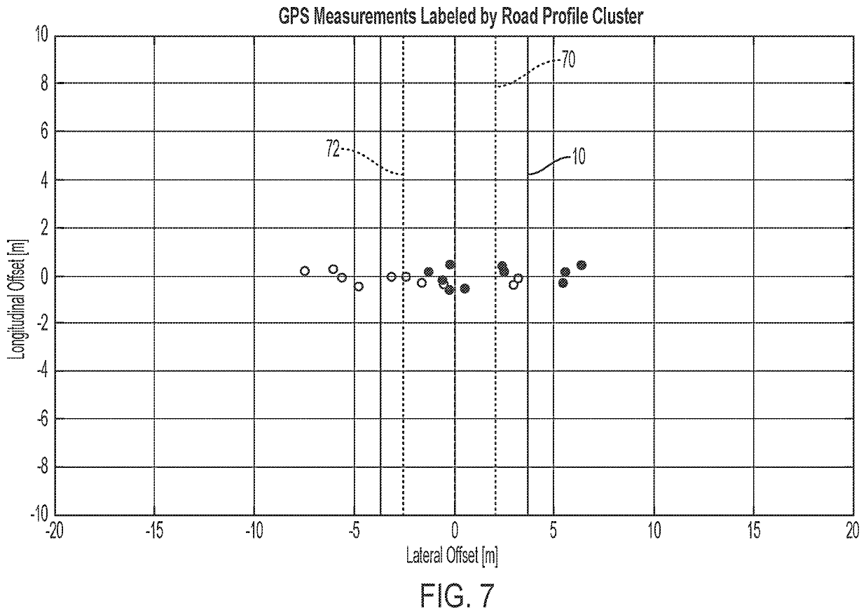

FIG. 7 illustrates an example of a process for determining which cluster in FIG. 6 belongs to the left lane and which belongs to the right lane. Using the cluster designations from the terrain-based clustering, GNSS measurements belonging to the same cluster may be averaged to get an estimate the offset of each lane's centerline. The uncertainty or standard deviation of the lane-center estimate may, for example, be determined from σₑₛₜ=1/\sqrt{n}σ_{gps} where n is the number of measurements being averaged. In some embodiments, once the uncertainty of the lane-center estimate drops below the distance between the lane-center estimates, the data may be used for lane ordering. For instance, we could rename “cluster 1” to “right lane” with calculated lane centerline 70. The calculated centerline of the left lane is line 72. For example, assuming a 5-meter standard deviation in GNSS measurement error, averaging 10 samples together would put the uncertainty in the lane-center estimate below half of a lane width.

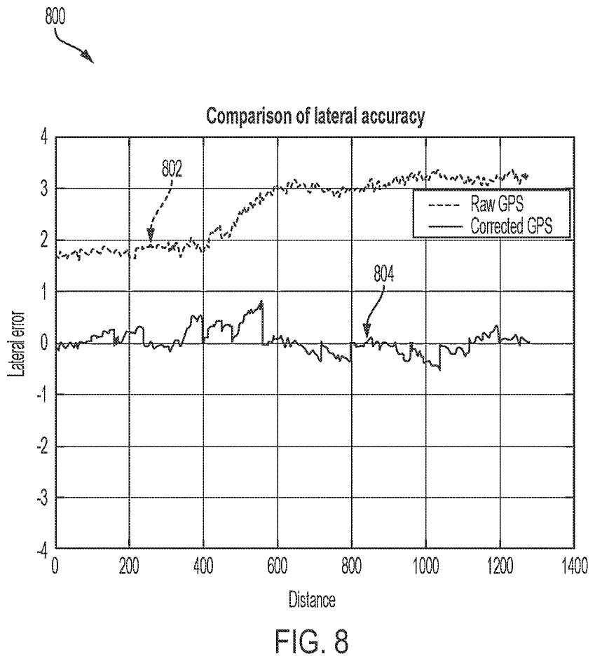

FIG. 8 illustrates a graph 800 (units of both axes is meters) illustrates an example of a correction or augmentation of current GNSS readings by relying on terrain-based information about the travel lanes of a road segment.

In some implementations, when a vehicle is traveling along a previously mapped road surface and is equipped with sensors, such as but not limited, to steering angle sensors, GNSS antennae and receiver, accelerometers and/or inertial measurement units attached to various sprung and un-sprung components of the vehicle, the data that is received from the sensors may be recorded and filtered to remove any undesired noise. This data may be combined in various ways to infer the behavior of the vehicle on the road.

In some implementations, as the vehicle is traversing a road segment, the recorded GNSS data may have an inherent low frequency drift over time. In some implementations, the low frequency drift may be at 0.05 Hz or slower, 0.1 Hz or slower, or 1 Hz or slower, as the disclosure is not limited to a particular rate of drift. An example of such an inherent low frequency drift is illustrated by line 802, depicting an exemplary raw GPS signal. This means that the GNSS signal may slightly deviate laterally and longitudinally from an actual position of the vehicle. The deviation may range from a few millimeters to a few meters, where the deviated GNSS trace is either slightly offset in the same lane as the vehicle is traversing or could lead to the GNSS trace falling closer to or in an adjacent lane on either side of the actual travel lane of the vehicle. In some cases, the GNSS trace may deviate by up to 5 meters or more in one direction. If this deviating signal is used to localize the vehicle in an absolute sense, the vehicle may end up localized far away from its actual location, which may result in an incorrect road surface preview signal to a controller (e.g., an autonomous driving controller, a semi-autonomous driving controller, an ADAS controller, etc.) which may, for example, be attempting to center the vehicle in a lane.

In some embodiments, accelerometer readings from one or more corners of the vehicle may be used to build up a road-surface profile (e.g., consisting of disturbances in a particular frequency range or frequency ranges in, for example, the direction of the vertical axis of each wheel). This signal may be considered a type of fingerprint of the road surface that is unique within a particular geographical area, road, or road segment. This fingerprint or road profile may also be used to distinguish lanes since each travel lane on a multi-lane road may have distinguishing irregularities (such irregularities may, for example, be incorporated in the reference or stored road-surface profile associated with a travel lane of a road segment). These irregularities or road-surface profile may be recorded in real time as the vehicle is driving along the road. These generated road profiles may then be compared to the saved road profile of various travel lanes to find a match.

In some embodiments, errors in lateral position received from GNSS signal during a current traverse of a road segment, may be at least partially corrected based on using a combination of previously collected road profile information (e.g. road-surface profile and/or road sub-surface profile) and associated previously collected GNSS data. In some embodiments, the similarity of current terrain information, e.g. road-surface profile and/or road sub-surface profile, and previously collected terrain information about various travel lanes of a particular road segment, may be used to determine the actual current travel lane of a vehicle in a multi-lane road segment.

In some embodiments, to make this determination, a buffer of a certain number of road profile data points may be collected. This buffering may be performed over the length of a road-segment, which may be e.g., an 80-meters long road segment. However, this disclosure is not limited to a distance buffer size of any particular length. In some embodiments, once this information is collected, the travel lane of the vehicle may be determined based on a similarity metric, between the current data and reference data associated with a particular travel lane of the road segment.

In some embodiments, once the actual travel lane is determined, the GNSS coordinates previously associated with the lane of travel, which may be determined as discussed above, may be recovered from data storage. This previously obtained and recorded GNSS coordinates may be used to at least partially correct errors in the current GNSS information.

In some embodiments, performing a comparison may involve converting both the current and previously collected GNSS traces from a global to a local coordinate frame. This conversion may, for example, involve using already established methods of converting spherical coordinates to planar coordinates such that the Euclidian distance may be calculated between the two sets of GNSS coordinates. In some embodiments, once the coordinates are, for example, in a planar frame of reference (e.g., X-Y), the offset calculation may be reduced to finding the lateral distance between the closest points between the two traces. This offset may generally be consistent for readings recorded at a GNSS receiver onboard a vehicle. This consistency means that the calculated offset may be constant or effectively constant while traveling over significant distances of, for example, 80 meters. Under certain conditions, the calculated offset may be constant or effectively constant while traveling over longer distances such as 150 meters, 200 meters, or 250 meters, as the disclosure is not so limited.

As discussed above, in some embodiments, the calculated offset may not change over the length of a road segment (e.g., 80 meters). In such cases, the calculated offset values may be subtracted from the live incoming GNSS (e.g., GPS) values during a current traverse. This process may be used to reduce an instantaneous inherent error in GNSS readings. Once the live road profile is matched with a section of road stored in the database (i.e., the live road profile is matched with a previously determined road profile associated with a travel lane), the travel lane of the vehicle may be know and the vehicle may localize longitudinally as long as the similarity value stays high enough between the stored road profile and the live, currently determined, road profile. If this matching continues for more than a certain distance (e.g., the length of a road segment, the distance of half of the length of a road segment, every 50 meters, 60 meters, 70 meters, 80 meters, etc.), a new lateral offset correction may be calculated and applied to the live GNSS values, hence reducing the accumulated lateral error further. An example of a corrected GPS trace is illustrated by line 804 in FIG. 8 where new lateral offsets are repeatedly performed to keep the lateral error at approximately zero

In some embodiments, the lateral error may eventually diminish to a small enough value to meet targets or requirements for localizing the vehicle within a lane, which may be required for supporting applications such as lane keep assist ADAS features, semi-autonomous driving features, and/or autonomous driving features, etc.

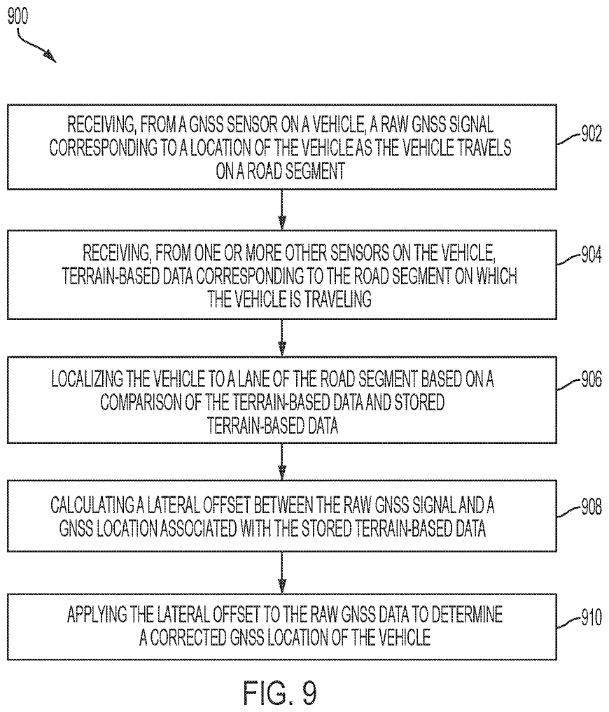

FIG. 9 illustrates an exemplary method for performing a real time GNSS augmentation or correction based on terrain-based information. The method includes (a) receiving (902), from a GNSS sensor on a vehicle, a GNSS signal corresponding to a location of the vehicle as the vehicle travels on a road segment, (b) receiving (904), from one or more other sensors on a vehicle, terrain-based data corresponding to the road segment on which the vehicle is currently traveling, (c) localizing (906) the vehicle to a travel lane of the road segment based on a comparison of the current terrain-based data from (b) and stored terrain-based data, (d) calculating (908) a lateral offset between the raw GNSS signal and a GNSS location associated with the stored terrain-based data, and (e) applying (910) the lateral offset to the raw GNSS data to determine a corrected real-time GNSS location of the vehicle.

In some implementations, the method also includes transmitting the corrected GNSS location of the vehicle to one or more controllers on the vehicle. In some instances, the one or more controllers on the vehicle includes at least one of an ADAS controller, a semi-autonomous driving controller, or an autonomous driving controller. These controllers may engage in performing or aiding lane keep assist functions, autonomous driving functions, etc.

In some implementations, the method also includes recalculating the lateral offset each time the vehicle travels a predetermined distance or after a predetermine time period. The predetermined distance may be approximately the length of one road segment of road data, which may be, in some implementations, approximately 80 meters. In some implementations, the method may also include recalculating the lateral offset at the end of each road segment or at the beginning of each road segment.

In some embodiments, information about the number of lanes in a road segment and/or lane specific information about road surface characteristics may be provided to a vehicle from a remote data storage, e.g., in the cloud. Such information may be used in or by one or more microprocessors, in the vehicle receiving the information, to determine the location of the vehicle, independently or in combination with GNSS data, and/or to control one or more systems in the vehicle, including but not limited to: active or semi-active suspension systems, EPS, ABS, ADAS, ESC, HVAC, and/or lighting systems.

Embodiments have been described where the techniques are implemented in circuitry and/or computer-executable instructions. It should be appreciated that some embodiments may be in the form of a method, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “having,” “containing,” “involving,” and variations thereof herein, is meant to encompass the items listed thereafter and equivalents thereof as well as additional items.

The word “exemplary” is used herein to mean serving as an example, instance, or illustration. Any embodiment, implementation, process, feature, etc. described herein as exemplary should therefore be understood to be an illustrative example and should not be understood to be a preferred or advantageous example unless otherwise indicated.

Labeling of steps in any method claim, by, for example, using labels such as “(a)”, “(b)”, “(c)”, etc. is for convenience of reference and is not intended to indicate any particular order of occurrence of those steps. Having thus described several aspects of at least one embodiment, it is to be appreciated that various alterations, modifications, and improvements will readily occur to those skilled in the art. Such alterations, modifications, and improvements are intended to be part of this disclosure, and are intended to be within the spirit and scope of the principles described herein. Accordingly, the foregoing description and drawings are by way of example only.

1. A method of determining the ordering of lanes in a road segment, the method comprising:
(a) receiving a multiplicity road-surface profiles, wherein each profile is based on data collected during each of a multiplicity of traverses of a length of the road segment;
(b) determining a representative lateral offset of each drive path during each traverse in (a);
(c) determining a degree of similarity between road surface profiles in (a);
(d) clustering the road surface profiles based the degree similarity determined in (c), wherein profiles with similarities greater than a preset threshold value are associated with the same lane;
(e) determining an average of the representative lateral offsets in (b) associated with each cluster in (d); and
(f) based on the averages in (e), determining the ordering of the lanes of the road segment.

2. The method of claim 1, further comprising determining the spacing between a calculated center line of at least two lanes of the road segment.

3. A method of determining a lateral position of a travel lane in a road segment, the method comprising:
(a) traversing the road segment, along a multiplicity of drive paths, with at least one vehicle;
(b) determining a road-surface profile and a lateral position of the multiplicity of drive paths in (a);
(c) clustering the road-surface profiles determined in (b);
(d) identifying a first cluster that includes a sufficient number of road-surface profiles, wherein the sufficient number is a number greater than a preset threshold value;
(e) determining a representative road-surface profile of the first cluster in (d);
(f) determining a representative lateral position of a set of drive paths corresponding to the road surface profiles in the first cluster; and
(g) determining a lateral position of a travel lane based on the representative lateral position determined in (f).

4. The method of claim 3, wherein the representative lateral position in (f) is determined by averaging the lateral positions of the set of drive paths.

5. The method of claim 3, wherein the lateral position of the travel lane is equal to the representative lateral position determined in (f).

6. The method of claim 3, wherein the representative lateral position of the set of drive paths in (f) is determined based on GNSS measurements obtained when traveling along each of the set of drive paths in (f).

7. The method of claim 6, wherein at least one GNSS measurement while traveling along each drive path.

8. The method of claim 3, wherein the number of lanes is equal to a number of clusters that include sufficient number of road-surface profiles.

9. The method of claim 3, further comprising determining the travel lane of a vehicle traveling along the road segment based on representative road-surface profile data associated with the travel lane.

10. The method of claim 9 wherein the representative road-surface profile data is received from a cloud data-storage system.

11. A method of determining the ordering of lanes in a road segment, the method comprising:
(a) receiving information about characteristics of subsurface structures below a multiplicity of drive paths, wherein the characteristics are based on data collected while driving over each of the multiplicity of drive paths of the road segment;
(b) determining a representative lateral offset of each of the multiplicity of drive paths in (a);
(c) determining a degree of similarity between the information received about the characteristics of subsurface structures below the multiplicity of drive paths (a);
(d) clustering the information in (c), wherein clusters with similarities greater than a preset threshold value are associated to the same lane of the road segment;
(e) determining an average of the representative lateral offsets in (b) associated with each drive paths in each cluster in (d); and
(f) based on the averages in (e), determining the ordering of the lanes of the road segment.

12. A method of augmenting a GNSS signal corresponding to a location of a vehicle, the method comprising:
(a) receiving, from a GNSS sensor on a vehicle, a raw GNSS signal corresponding to a location of the vehicle as the vehicle travels on a road segment;
(b) receiving, from one or more other sensors on the vehicle, terrain-based data corresponding to the road segment on which the vehicle is traveling;
(c) localizing the vehicle to a lane of the road segment based on a comparison of the terrain-based data from (b) and stored terrain-based data;
(d) calculating a lateral offset between the raw GNSS signal and a GNSS location associated with the stored terrain-based data; and
(e) applying the lateral offset to the raw GNSS data to determine a corrected GNSS location of the vehicle.

13. The method of claim 13, further comprising transmitting the corrected GNSS location of the vehicle to one or more controllers on the vehicle.

14. The method of claim 14, wherein the one or more controllers on the vehicle includes at least one of an ADAS controller, a semi-autonomous driving controller, or an autonomous driving controller.

15. The method of claim 13, further comprising, recalculating the lateral offset each time the vehicle travels a predetermined distance.

16. The method of claim 13, further comprising, recalculating the lateral offset at the end of each road segment or at the beginning of each road segment.

17. The method of claim 13, further comprising determining a GNSS error for a particular region based on the lateral offset between the raw GNSS signal and a GNSS location associated with the stored terrain-based data and transmitting the GNSS error to other vehicles in the region.

18. A method of determining a lane of travel of a vehicle while the vehicle is traveling along a multi-lane road segment, the method comprising:
collecting current road-profile information with at least one on-board sensor;
from a database, receiving previously collected representative road-profile information and representative lateral position data about each of the at least two lanes of travel associated with the road segment;
comparing the current road-profile information with the representative road-profile information received about each of the at least two lanes of travel; and
selecting a lane of travel, from among the at least two lanes of travel associated with the road segment, with representative road-profile information most similar to the current road-profile information; and
determining the current lane of travel to be the selected lane of travel.

19. The method of claim 18, wherein the lane of travel is an unmarked lane of travel associated with the road segment.

20. The method of claim 18, wherein the current road profile information is a current road-surface profile, and each previously collected representative road-profile information is a previously collected representative road-surface profile.

21. The method of claim 18, wherein the current road profile information is a current road-subsurface profile and each previously collected representative road-profile information is a previously collected representative road-subsurface profile.

22. The method of claim 18, further comprising determining the lateral position of the current lane of travel to be the lateral position of the selected lane of travel.

23. The method of claim 22, further comprising:
determining a first lateral position of at least one point along the current lane of travel, based on information from a GNSS receiver when the vehicle is located at the at least one point;
determining a second lateral position of the at least one point along the current lane of travel, based the lateral position of the current lane of travel;
based at least on a discrepancy between the first lateral position and the second lateral position, determining an error in the information received from the GNSS receiver.
